(19) United States
(12) Patent Application Publication
(10) Pub. No.: US 2026/0026918 A1
(43) Pub. Date: Jan. 29, 2026

(54) A METHOD FOR PROCESSING IMAGE, AN ELECTRONIC APPARATUS AND A COMPUTER READABLE STORAGE MEDIUM

(71) Applicant: MEDIT CORP., Seoul (KR)

(72) Inventor: Dusu KIM, Seoul (KR)

(21) Appl. No.: 18/994,011

(22) PCT Filed: Jul. 13, 2023
(86) PCT No.: PCT/KR2023/010057

§ 371 Date: Jan. 13, 2025

(30) Foreign Application Priority Data
Jul. 13, 2022 (KR) 10-2022-0086432
Jul. 12, 2023 (KR) 10-2023-0090638

(51) Int. Cl. A61C 9/00; G06F 3/04815; G06T 17/20

(52) U.S. Cl. CPC A61C 9/0053; G06F 3/04815; G06T 17/20

(57) ABSTRACT

A method for processing an image, an electronic apparatus performing the same, and a computer readable storage medium storing the same may be provided. The method for processing an image includes: receiving at least one intraoral image; loading scan data corresponding to the at least one intraoral image; calculating based on the scan data; setting a plurality of reference points in the scan data based on the calculating; and aligning the scan data based on an occlusal plane generated based on the plurality of reference points.

### TECHNICAL FIELD

The present disclosure relates to a method for processing an image, an electronic apparatus, and a computer readable storage medium.

### BACKGROUND ART

Intraoral structures (splints, temporary teeth, etc.) that are inserted and arranged in an oral cavity may be used to treat temporomandibular joint disorders, dental trauma, cavities, gum disease, etc. In order to manufacture the intraoral structures by reflecting the characteristics of the oral cavity into which they are inserted, intraoral images obtained by scanning the oral cavity are utilized in the manufacturing of the intraoral structures.

In manufacturing the intraoral structures, a front direction of the oral cavity should be specified, or in some cases, a detailed anatomical coordinate system for teeth may be required. For example, by designating the plane on which opposing teeth are arranged, a margin line may be extracted, a prosthesis insertion direction may be determined, and the left/right of teeth may be determined by recognizing a midline of an arch, or an anterior and a post may be recognized/separated by recognizing the front direction of the oral cavity, which may be of great help in the subsequent follow-up work.

However, in the current process of manufacturing the intraoral structures, the front direction of the oral cavity and an occlusal plane are specified through the user's manual work, so there is a problem in that it takes a lot of time for manufacturing and the accuracy is low.

### DISCLOSURE

### Technical Problem

The present disclosure attempts to efficiently and accurately specify a front direction of an oral cavity and an occlusal plane through calculation processing of scan data.

### Technical Solution

According to an exemplary embodiment, a method for processing an image includes: receiving at least one scan data, extracting an initial occlusal plane direction of the scan data based on mesh data included in the at least one scan data, generating cusp information of the scan data based on the initial occlusal plane direction, setting a front direction and a midline of the scan data based on the cusp information, generating a cylinder adjacent to the scan data to adjust the midline, and setting an occlusal plane of the scan data based on the adjustment operation.

According to another exemplary embodiment, an electronic apparatus includes a user interface device, a processor, and a memory storing instructions executable by the processor, in which the processor executes the instructions to receive at least one scan data, extract an initial occlusal plane direction of the scan data based on mesh data included in the at least one scan data, generate cusp information of the scan data based on the initial occlusal plane direction, set a front direction and a midline of the scan data based on the cusp information, generate a cylinder adjacent to the scan data to adjust the midline, and set an occlusal plane of the scan data based on the adjustment operation.

### Advantageous Effects

According to the disclosed exemplary embodiments, it is possible to automatically specify the front direction of the oral cavity and the occlusal plane and align the intraoral image to reduce the time required to manufacture the intraoral structure.

According to the disclosed exemplary embodiments, it is possible to elaborately aligning the intraoral images by arranging the midline of the arch between the central incisors.

### DESCRIPTION OF THE DRAWINGS

FIG. 1 is a diagram for describing an image processing system including an electronic apparatus according to an exemplary embodiment.

FIG. 2 is a block diagram illustrating a configuration of an electronic apparatus according to an exemplary embodiment.

FIG. 3 is a flowchart illustrating a method for processing an image of an electronic apparatus according to an exemplary embodiment.

FIGS. 4 and 5 are diagrams for describing scan data, maxillary scan data, and mandibular scan data according to an exemplary embodiment.

FIG. 6 is a flowchart illustrating the method for processing an image of an electronic apparatus according to an exemplary embodiment.

FIGS. 7 to 9 are diagrams for describing extracting an initial occlusal plane direction according to an exemplary embodiment.

FIGS. 10 to 12 are diagrams for describing generating cusp information according to an exemplary embodiment.

FIGS. 13 and 14 are diagrams for describing setting a front direction and a midline according to an exemplary embodiment.

FIGS. 15 to 17 are diagrams for describing finely adjusting the midline according to an exemplary embodiment.

FIG. 18 is a diagram for describing setting the occlusal plane according to an exemplary embodiment.

### MODE FOR INVENTION

Hereinafter, exemplary embodiments of the present invention will be described in detail with reference to the accompanying drawings so that those skilled in the art to which the present invention pertains may easily practice the present invention. The present invention may be implemented in various different forms and is not limited to exemplary embodiments provided herein.

Portions unrelated to the description will be omitted in order to obviously describe the present invention, and similar components will be denoted by the same reference numerals throughout the present specification. The term ‘part’ (portion) used in the specification may be implemented as software or hardware, and according to embodiments, multiple ‘parts’ may be implemented as one unit (element), or one ‘part’ may include multiple elements. Hereinafter, operating principles and embodiments of the present invention are described with reference to the attached drawings below.

In addition, the size and thickness of each component illustrated in the drawings are arbitrarily indicated for convenience of description, and the present invention is not necessarily limited to the illustrated those. In the drawings, the thickness of layers, films, panels, regions, etc., are exaggerated for clarity. In addition, in the accompanying drawings, thicknesses of some of layers and regions have been exaggerated for convenience of explanation.

In addition, it will be understood that when an element such as a layer, a film, a region, or a plate is referred to as being “on” another element, it can be directly on the other element or intervening elements may also be present. In contrast, when an element is referred to as being “directly on” another element, there are no intervening elements present. In addition, when an element is referred to as being “on” a reference element, it can be positioned on or beneath the reference element, and is not necessarily positioned on the reference element in an opposite direction to gravity.

In addition, unless explicitly described to the contrary, the word “comprise”, and variations such as “comprises” or “comprising”, will be understood to imply the inclusion of stated elements but not the exclusion of any other elements.

Further, throughout the specification, the word “plane” refers to a view when a target is viewed from the top, and the word “cross section” refers to a view when a cross section of a target taken along a vertical direction is viewed from the side.

In addition, terms including an ordinal number such as first, second, or the like, used in the present disclosure may be used to describe various components. However, these components are not limited to these terms. The above terms are used solely for the purpose of distinguishing one component from another.

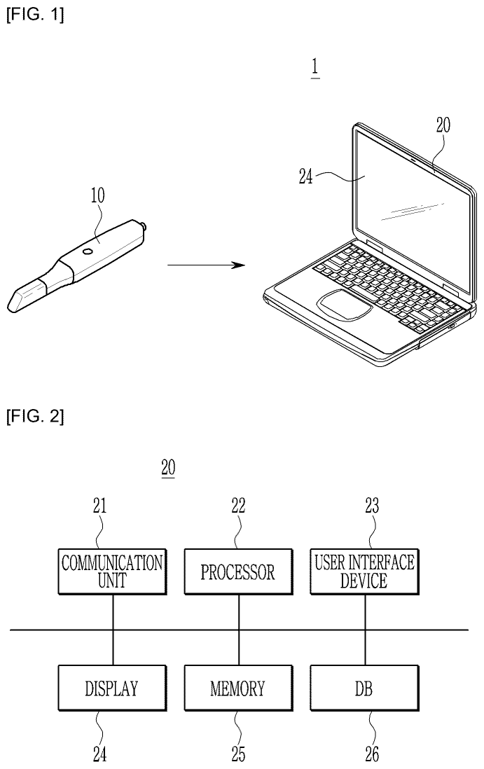

FIG. 1 is a diagram for describing an image processing system including an electronic apparatus according to an exemplary embodiment. FIG. 2 is a block diagram illustrating a configuration of an electronic apparatus according to an exemplary embodiment.

Referring to FIG. 1 and FIG. 2, a system 1 for processing an image may include a scanner 10 and an electronic apparatus 20.

In this specification, an ‘object’ is a capturing subject and may include a person, an animal, or a part thereof. For example, the object may include a part (an organ, an organ, etc.) of a body, a phantom, etc. In addition, for example, the object may include a plaster model modeling an oral cavity, a denture such as a denture or a prosthesis, a dentiform in a shape of teeth, etc. For example, the object may include a tooth, a gingiva, at least a portion of the oral cavity, and/or artificial structures (e.g., an orthodontic device including bracket and wire, dental restorations including implant, abutment, artificial teeth, inlay and onlay, and orthodontic auxiliary tools inserted into the oral cavity, etc.) that may be inserted into the oral cavity, the tooth or gingiva to which the artificial structures are attached, etc.

The scanner 10 may mean a device that acquires an image related to the object. The scanner 10 may mean a scanner 10 that acquires an intraoral image related to the oral cavity used for oral treatment. The scanner 10 may acquire at least one of a two-dimensional (2D) image and a three-dimensional (3D) image. In addition, the scanner 10 may acquire at least one 2D image of the oral cavity, and generate a 3D image (or a 3D model) of the oral cavity based on at least one acquired 2D image. In addition, the scanner may acquire at least one two-dimensional image of the oral cavity, and transmit the at least one two-dimensional image to the electronic apparatus 20.

The electronic apparatus 20 may also image a surface of at least one of the scanner 10 tooth model or tooth, a gingiva, and the artificial structures (e.g., the orthodontic device including the bracket and wire, the orthodontic auxiliary tools inserted into the oral cavity including the implant, the artificial teeth, and splint, etc.) insertable into the oral cavity, and for this purpose, may acquire surface information about the object as raw data.

The electronic apparatus 20 may generate the 3D image of the oral cavity based on at least one received 2D image. Here, the ‘3D image’ may be generated by three-dimensionally modeling the object based on the received raw data, and thus may be called a ‘3D model’. In addition, in the present disclosure, a model or image representing an object two-dimensionally or three-dimensionally may be collectively called an ‘image’.

For example, the scanner 10 may be an intraoral scanner having a form that may be inserted into the oral cavity, and according to the exemplary embodiment, the intraoral scanner may be a wired device or a wireless device, and the technical idea of the present disclosure is not limited to the form of the intraoral scanner.

According to an exemplary embodiment, the intraoral scanner may be a hand-held type scanner that can be held by hand and carried. The intraoral scanner may be inserted into the oral cavity, and scan teeth in a non-contact manner to obtain an image of the oral cavity including at least one tooth, and scan the inside of the patient's oral cavity using at least one image sensor (e.g., an optical camera, etc.).

According to an exemplary embodiment, the scanner 10 may be a table type scanner that may be used for dental treatment. The table type scanner may be a scanner that acquires the surface information on an object as the raw data by scanning the object using the rotation of the table. The table scanner may scan a surface of an object such as a plaster model or an impression model modeling the oral cavity.

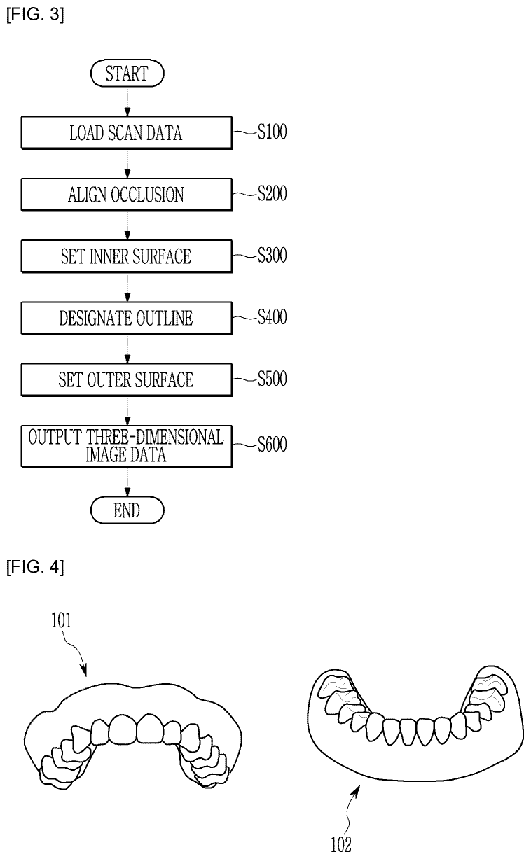

The electronic apparatus 20 may receive the raw data from the scanner 10 and process the received raw data to output a 3D image for the raw data. According to an exemplary embodiment, the output 3D image may be 3D image data including the intraoral structure such as the splint for the received raw data. For ease of description, a specific description of the scan data is described later with reference to FIGS. 4 and 5.

The electronic apparatus 20 may be any electronic apparatus that is connected to the scanner via a wired or wireless communication network, and may receive a 2D image acquired by scanning the object from the scanner and generate, process, display, and/or transmit an image based on the received 2D image.

The electronic apparatus 20 may store and execute dedicated software to perform at least one operation of receiving, processing, storing, and/or transmitting the 3D image or the 2D image of the object. For example, the dedicated software may perform processing operations such as region extraction and region setting on the received scan data, and perform data selection, reference point adjustment, alignment, etc., based on the processing operations to perform at least one operation such as generation, storing, and transmitting the 3D image including the artificial structures such as the splint. The electronic apparatus 20 may be a computing device such as a smart phone, a laptop computer, a desktop computer, a PDA, or a tablet PC, but is not limited thereto. In addition, the electronic apparatus 20 may exist in the form of a server (or server device) for processing intraoral images.

The electronic apparatus 20 may include a communication unit 21, a processor 22, a user interface device 23, a display 24, a memory 25, and a database 21. However, not all of the illustrated components are essential components. The electronic apparatus 20 may be implemented by more components than the illustrated components, or may be implemented by fewer components. The components will be described below.

The communication unit 21 may perform communication with an external device. Specifically, the communication unit 21 may be connected to a network by wire or wirelessly to perform communication with the external device. Here, the external device may be the scanner 10, a server, a smartphone, a tablet, a PC, etc.

The communication unit 21 may include a communication module that supports one of various wired and wireless communication methods. For example, the communication module may be in the form of a chipset, or may be a sticker/barcode (e.g., a sticker including an NFC tag), etc., including information necessary for communication. In addition, the communication module may be a short-range communication module or a wired communication module.

For example, the communication unit 21 may support at least one of wireless LAN, wireless fidelity, Wi-Fi direct, Bluetooth, Bluetooth low energy, wired LAN, near field communication, Zigbee, Infrared data association (IrDA), 3G, 4G, and 5G.

In an exemplary embodiment, the scanner 10 may transmit the acquired raw data to the electronic apparatus 20 through the communication module. The image data acquired by the scanner may be transmitted to the electronic apparatus 20 connected through the wired or wireless communication network.

The processor 22 controls the overall operation of the electronic apparatus 20 and may include at least one processor, such as a CPU. The processor 22 may include at least one specialized processor corresponding to each function, or may be a processor integrated into one.

The processor 22 may receive the raw data through the communication unit 21. For example, the processor 22 may receive the raw data from the scanner 10 through the communication unit 21. In this case, the processor 22 may generate the 3D image data (e.g., surface data, mesh data, etc.) that represents the shape of the surface of the object three-dimensionally based on the received raw data. Hereinafter, the scan data that becomes the calculation target of the electronic apparatus 20 may include the 3D image data.

The processor 22 may receive library data from the external device through the communication unit 21. The library data may be data pre-stored in the electronic apparatus 20 or the raw data or the 3D image data acquired through the external device, but is not limited thereto. Here, the external device may be a camera capable of capturing pictures or videos, or an electronic apparatus having a camera function. In addition, the external device may be an intraoral scanner capable of scanning the inside of a patient's mouth.

The processor 22 may control the user interface device 23 or the display 24 to receive a predetermined command or data from a user.

The processor 22 may execute a program stored in the memory 25, read an image, data, or file stored in the memory 25, or store a new file in the memory 25. The processor 22 may execute instructions stored in the memory 25. The stored program may include, but is not limited to, dedicated software.

The processor 22 may perform a calculation operation on mesh data, data, etc., included in the scan data. For example, the processor 22 may perform an operation of obtaining an average of normal vectors of mesh data constituting scan data, generating a 3D-oriented bounding box including the plurality of mesh data or the plurality of reference points, generating a 2D-oriented bounding box, and/or performing a convex hull algorithm operation for the plurality of mesh data or the plurality of reference points.

The bounding box means a box of the minimum size that surrounds a plurality of position data or a specific object, and a 3D bounding box may have a rectangular shape, and a 2D bounding box may have a rectangular shape.

The Convex hull algorithm is an algorithm for generating a convex polyhedron containing points in a finite set of points, and according to an exemplary embodiment, a static calculation algorithm or a dynamic calculation algorithm utilizing triangulation may be used. A convex polyhedron may include a plurality of vertices and surfaces.

The processor 22 may extract the vector from the bounding box. The processor 22 may extract a vector having a direction in an extension direction and a size of an edge length of the 3D-oriented bounding box and, or a vector having a direction in an extension direction and a size of a side length of the 2D-oriented bounding box. For example, the processor 22 may perform an operation of extracting a direction vector for a minimum edge having a minimum length of the 3D-oriented bounding box, or extracting a vector for a long side of the 2D-oriented bounding box. In addition, the processor 22 may calculate an average vector of the extracted vectors.

The processor 22 may calculate a complexity representing surface curvature for scan data for a specific direction. For example, the processor 22 may calculate the complexity for the surface curvature using the Laplacian of Gaussian (LoG), which is a combination of the Laplacian that may find the difference in slope in the scan data and the Gaussian that is advantageous for noise removal.

The processor 22 may recognize an object in the scan data, extract a portion of an area, or calculate the area or volume of the recognized object or the extracted area. For example, the processor 22 may separately recognize the type of teeth by using curvature information, cusp information, anatomical feature shapes, etc., of the scan data, or distinguish a space between teeth. According to the disclosed exemplary embodiment, the recognition operations of the processor 22 are not limited to the examples of utilizing the information, and the recognition operations may be performed through the inference of the object recognition artificial intelligence algorithm. The cusp information may include the number, arrangement, etc., of cusp points where a molar in the scan data come into contact.

The processor 22 may select data based on a specific direction, a predetermined value, etc. For example, the processor 22 may perform an operation of generating a local maximum point based on the initial occlusal plane direction in the data in the scan data, or selecting a cusp point based on a predetermined value, calculated area, etc., among a plurality of local maximum points.

The processor 22 may specify the direction of the scan data based on the reference points, and set the midline of the scan data. For example, the processor 22 may perform an operation of specifying the front direction of the scan data based on an outer cusp of a left first molar, an outer cusp of a right first molar, and central cusp points in a central incisor among the cusp points, and setting the midline that divides the left and right sides of the scan data. The midline is a line passing through the center of the arch of the scan data, and the left and right of the oral cavity may be distinguished through the midline.

The processor 22 may generate a cylinder that fits the space between the objects using the curvature information, etc. For example, the processor 22 may generate a cylinder that is disposed in contact with the central incisors in the space between the central incisors.

The processor 22 may perform an adjustment operation for the midline. Specifically, the adjustment operation may be performed using the fitted cylinder for the reference point through which the midline passes, and the point through which the midline passes may be adjusted.

The processor 22 may set a plane based on a plurality of reference points. For example, the processor 22 may set an occlusal plane for the scan data based on three reference points.

The user interface device 23 may mean a device that receives data from a user to control the electronic apparatus 20. The display 24 may include an output device for displaying a result image according to the operation of the electronic apparatus 20 or the 3D image output from the electronic apparatus 20.

The user interface device 23 may include, for example, an input device such as a mouse, a joystick, an operation panel, a touch sensitive panel that receives user input, and the display 24 may include a display panel that displays a screen, etc.

The database 26 may store data and a dataset for training an artificial intelligence algorithm of dedicated software, and may provide data for training according to a request of the dedicated software. The artificial intelligence algorithm may train the training data of teeth stored in the database 26 using a deep learning method and distinguish the characteristics of data representing teeth. Meanwhile, the dedicated software may use the extracted or recognized tooth region data when performing an occlusal plane alignment step, an inner setting step, an outline designation step, etc., which will be described later, by extracting maxillary tooth region data and mandibular tooth region data from scan data or recognizing objects according to tooth characteristics.

In the present disclosure, the artificial intelligence (AI) means a technology that imitates human learning ability, reasoning ability, and perception ability and implements them with a computer, and may include the concepts of machine learning and symbolic logic. The machine learning (ML) may be an algorithm technology that classifies or trains the characteristics of input data on its own. The technology of the artificial intelligence may analyze input data as the machine learning algorithm, train the results of the analysis, and make the judgment or prediction based on the results of the training. In addition, technologies that imitate the cognitive and judgment functions of the human brain by utilizing the machine learning algorithm may also be understood as part of the category of the artificial intelligence. For example, the fields of technology of linguistic understanding, visual understanding, inference/prediction, knowledge expression, and motion control may be included.

In this disclosure, the machine learning may mean a process of training a neural network model using experience in processing data. Through the machine learning, the computer software may mean improving its own data processing ability. A neural network model is constructed by modeling correlations between data, and the correlations may be expressed by multiple parameters. The neural network model extracts and analyzes features from given data to derive correlations between data, and repeats the process to optimize the parameters of the neural network model, which may be called the machine learning.

For example, the neural network model may train a mapping (correlation) between inputs and outputs for data given as input-output pairs. Alternatively, even when only the input data is given, the neural network model may derive regularities between the given data and train the relationship.

In the present disclosure, the artificial intelligence training model, the machine learning model, or the neural network model may be designed to implement a human brain structure on a computer, and may include a plurality of network nodes that simulate neurons of a human neural network and have weights. The plurality of network nodes may simulate synaptic activity of neurons that exchange signals through synapses, and thus may have a connection relationship between each other. In the artificial intelligence learning model, the plurality of network nodes may be located in layers of different depths and may exchange data according to the convolution connection relationship.

Although the database 26 is illustrated as being included in the electronic apparatus 20 in the drawing, it is not limited thereto and may be arranged in the form of a server (or server device) or the like outside the electronic apparatus 20 to provide data for training and store training results.

FIG. 3 is a flowchart illustrating a method for processing an image of an electronic apparatus according to an exemplary embodiment. FIGS. 4 and 5 are diagrams for describing scan data, maxillary scan data, and mandibular scan data according to an exemplary embodiment.

Referring to FIGS. 1 to 5, the electronic apparatus 20 loads scan data 100

(S100). The electronic apparatus 20 loads the scan data 100 generated based on the image received from the external device including the scanner 10, etc., through the communication unit 21.

The electronic apparatus 20 loads scan data 101 processed based on the received image or pre-stored in the processor 22 or the user interface device 23, and may display the loaded scan data 101 through the display 24.

The scan data 100 may be the 2D image of the object, the 3D model representing the object in three dimensions, or the 3D image data, and specifically, may be a 3D intraoral model. The intraoral images in FIGS. 4 and 5 correspond to the scan data 100 and are 2D or 3D expressions of the objects of the scan data 100, and may include a maxillary pre-preparation (prep) image, an maxillary prep image, a mandibular pre-prep image, a mandibular prep image, an occlusal image including a maxillary-related image and a mandibular-related image, as in contents for the scan data 100 described below.

In the present disclosure, the prep may mean a series of preparatory processes for removing a portion of the enamel and dentin of the teeth so as to prevent interference between natural teeth and splints when performing prosthetics such as crowns and prostheses.

A “3D intraoral model” may mean a model that three-dimensionally models the oral cavity based on the raw data acquired by the scanning operation of the scanner. In addition, the “3D intraoral model” may mean a structure that is three-dimensionally modeled based on the data acquired by scanning an object such as a tooth, an impression, and an artifact. The 3D intraoral model is generated by modeling the internal structure of the oral cavity in three dimensions, and may be called a 3D scan model, a 3D model, or a tooth model. For example, a format of the 3D intraoral model may be one of standard triangle language (STL), OBJ, and polygon file formats, and is not limited to the above examples. In addition, the 3D intraoral model may include information such as geometric information, color, texture, and a material for a 3D shape.

In addition, the “polygon” may mean a polygon which is the smallest unit used when expressing the 3D shape of the 3D intraoral model. For example, the surface of the 3D intraoral model may be expressed as triangular polygons. For example, a polygon may be composed of at least three vertices and one face. A vertex may include information such as location, color, and normal. A mesh may be an object in a 3D space created by gathering multiple polygons. As the number of polygons representing the 3D intraoral model increases, the object may be expressed in detail.

The scan data 100 may include at least one of the maxillary scan data 101 and the mandibular scan data 102. Specifically, the scan data 100 may load any one of the maxillary prep data, the maxillary preparation data, the mandibular prep data, the mandibular preparation data, and the occlusal data including the maxillary-related data and the mandibular-related data.

In the present disclosure, the prep means a series of preparatory processes for removing a portion of enamel and dentin of the tooth so as to prevent interference between the natural tooth and the prosthesis when performing prosthetics such as crowns and bridges. The prep data may be data in which the enamel and dentin of the tooth are removed through the preparatory process, and the pre-prep data may be data before a portion of the enamel and dentin of the tooth are removed through the preparatory process.

The scan data 100 may include gingival region 200, maxillary tooth region data 301, and mandibular tooth region data 302, which are arranged in the maxillary scan data 101 and the mandibular scan data 102.

The electronic apparatus 20 may load at least one of the maxillary scan data 101, the mandibular scan data 102, and the occlusal data including the maxillary scan data 101 and the mandibular scan data 102.

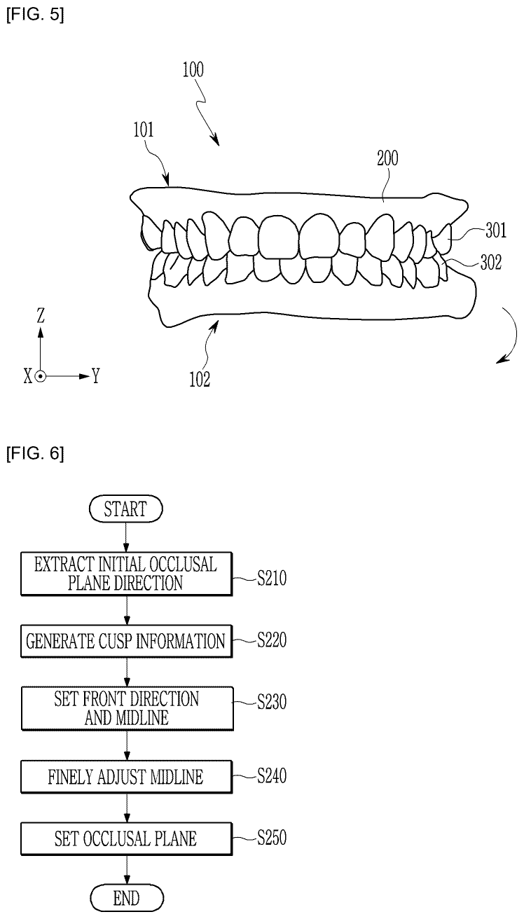

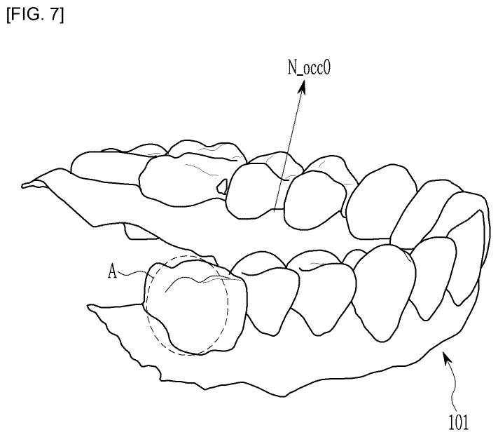

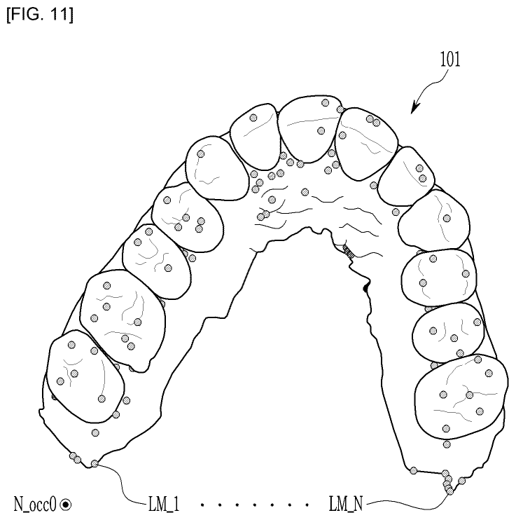

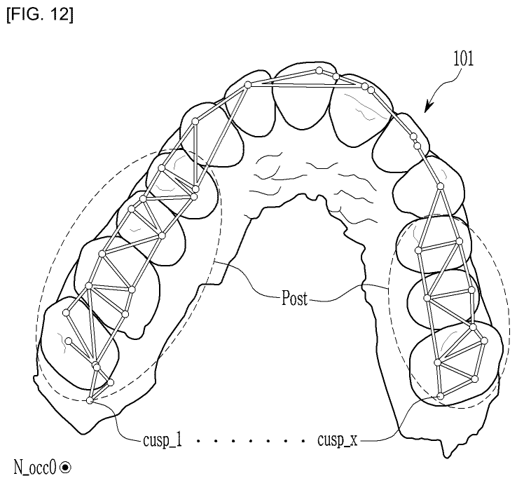

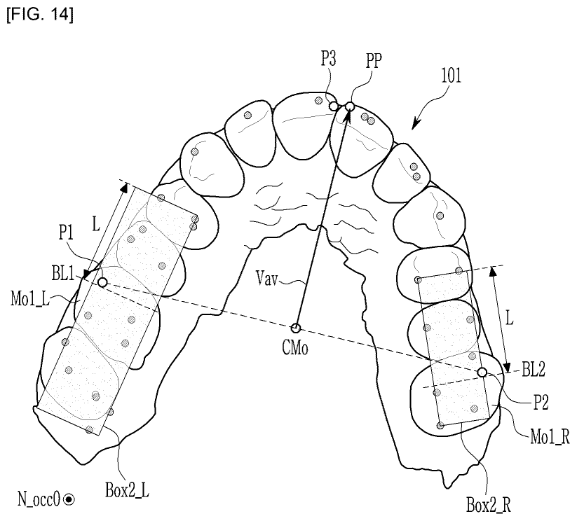

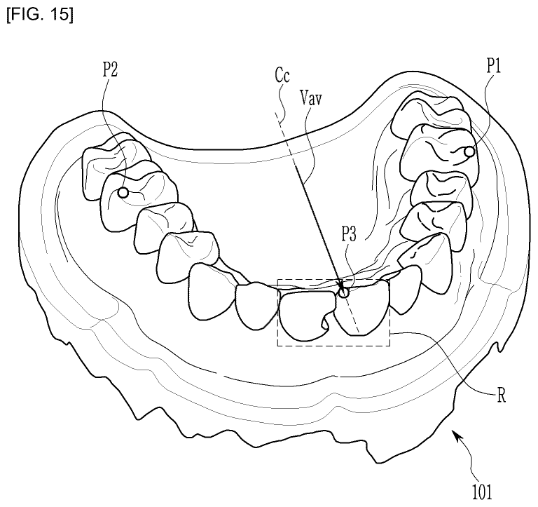

The electronic apparatus 20 analyzes and aligns the shape of the received scan data 100 (S200). In the corresponding step, an occlusal plane and a midline for the scan data 100 are set, and the electronic apparatus 20 may automatically align the scan data 100, the maxillary scan data 101, or the mandibular scan data 102 according to the occlusal plane, and may display the left and right alignment by a midline through the display 24. A specific description of the corresponding step will be described later in the description of FIGS. 6 to 18.

In addition, at the corresponding stage, the user may manually designate a reference point on the scan data 100 to set the front direction and the occlusal plane of the scan data 100, and align the scan data 100 along the set occlusal plane. For example, the user may select some data of the scan data 100 through the user interface device 23 at the corresponding step, and align the scan data 100 with the selected data as a reference point.

The electronic apparatus 20 sets the inner surface of the intraoral structure for the aligned scan data 100 (S300).

In the corresponding step, the electronic apparatus 20 may designate the direction in which the intraoral structure is to be inserted by considering the undercut of the aligned scan data 100. For example, when manufacturing the splint of the intraoral structure, the electronic apparatus 20 may calculate the area of the tooth region in the scan data 100, and designate the direction in which the intraoral structure is to be inserted by considering the undercut and block out according to the direction in which the intraoral structure is to be inserted. The insertion efficiency and retention power of the intraoral structure may be improved by designating the insertion direction of the intraoral structure as described above.

Based on the inner offset distance, the surface smoothness, etc., input from the user interface device 23, the electronic apparatus 20 may set the inner surface of the intraoral structure to be output. The inner offset distance may mean a normal distance between the scan data 100 and the inner surface of the intraoral structure. The surface smoothness may mean the roughness of the inner surface of the intraoral structure.

The electronic apparatus 20 designates the outline of the intraoral structure for the automatically aligned scan data 100 (S400).

Based on the buccal height, the lingual height, etc., input from the user interface device 23, the electronic apparatus 20 may designate the outline of the intraoral structure to be output. For example, when manufacturing the splint which is the intraoral structure, the buccal height is a height of the outer wall of the tooth facing a cheek based on a lower surface of the tooth region, and for example, the buccal height may mean a height formed along the outer wall of the tooth based on the bottom surface of the tooth region of the maxillary scan data 101. The higher the buccal height, the closer the buccal outline formed is to the gingiva. The lingual height is a height of the inner wall of the tooth facing a tongue based on a bottom surface of the tooth region, and for example, the lingual height may mean a height formed along the inner wall of the tooth based on the bottom surface of the tooth region of the maxillary scan data 101. The higher the lingual height, the closer the lingual outline formed is to the gingiva.

The electronic apparatus 20 sets the outer surface of the intraoral structure for the aligned scan data 100 (S500).

Based on the thickness, the surface smoothness, etc., input from the user interface device 23, the electronic apparatus 20 may designate the outer surface of the intraoral structure to be output. The electronic apparatus 20 may form the 3D image for the intraoral structure by setting the thickness in the occlusal direction based on the predetermined occlusal thickness. For example, when manufacturing the splint which is the intraoral structure, the thickness may mean the thickness from the inner surface of the intraoral structure in the buccal/lingual direction. The surface smoothness may mean the roughness of the outer surface of the intraoral structure. The predetermined occlusal thickness may mean the maximum thickness value that the intraoral structure extends in the occlusal direction.

The electronic apparatus 20 generates the 3D image data including the intraoral structure through the information set and designated in steps S300 to S500 (S600). The 3D image of the generated intraoral structure may be transmitted to the external device through the communication unit 21 and output to the intraoral structure. The external device may be a 3D printer, but is not limited to the above example according to an exemplary embodiment.

According to an exemplary embodiment, the electronic apparatus 20 may perform steps S200 to S500 at once without an intermediate input from the user. The electronic apparatus 20 loads the scan data 100 (S100), receives inputs, such as the inner offset distance, the surface smoothness, the buccal height, the lingual height, and the thickness, from the user, and automatically performs steps S200 to S500 without intermediate intervention from the user to generate the 3D image data (S600).

According to an exemplary embodiment, the electronic apparatus 20 may automatically perform steps S200 to S500 without user intervention by utilizing the inner surface offset distance, the surface smoothness, the buccal height, the lingual height, the thickness, etc., stored in the memory 25.

The electronic apparatus 20 may automatically perform steps S200 to S500 without the user intervention, thereby reducing the time required for the manufacturing of the intraoral structure.

According to an exemplary embodiment, the electronic apparatus 20 may generate the 3D image data for the intraoral structure through an inference operation of the artificial intelligence algorithm without a separate input other than the loaded scan data 100 (S600). The artificial intelligence algorithm may perform training on the intraoral structure corresponding to the plurality of scan data before the inference operation, and perform the inference operation related to the 3D image data of the intraoral structure suitable for the loaded scan data 100.

According to an exemplary embodiment, the electronic apparatus 20 may adjust an occlusion state or a minimum distance between arches (distance to antagonist) in each step of steps S300 to S500 through the user input regarding the occlusion state or the minimum distance between the arches between the maxillary scan data 101 and the mandibular scan data 102 in the scan data 100. During the adjustment operation, the electronic apparatus 20 may perform the calculation operation on the scan data 100 to display the occlusion state or the minimum distance between the arches together.

Through the adjustment and calculation operations, the user may produce the intraoral structure by considering the distance and space in the patient's oral cavity.

Hereinafter, step S200 will be described with reference to FIGS. 6 to 18. FIG. 6 is a flowchart illustrating the method for processing an image of an electronic apparatus according to an exemplary embodiment.

Referring to FIGS. 1 to 6, the electronic apparatus 20 extracts the initial occlusal plane direction for the scan data 100 (S210).

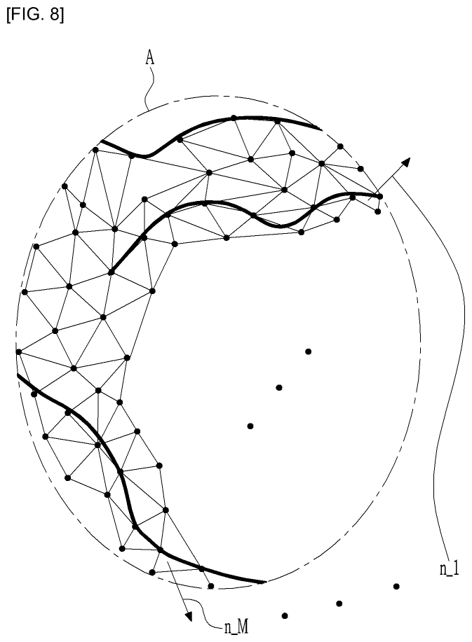

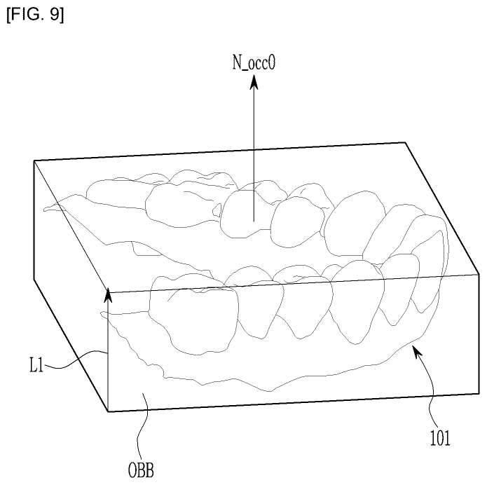

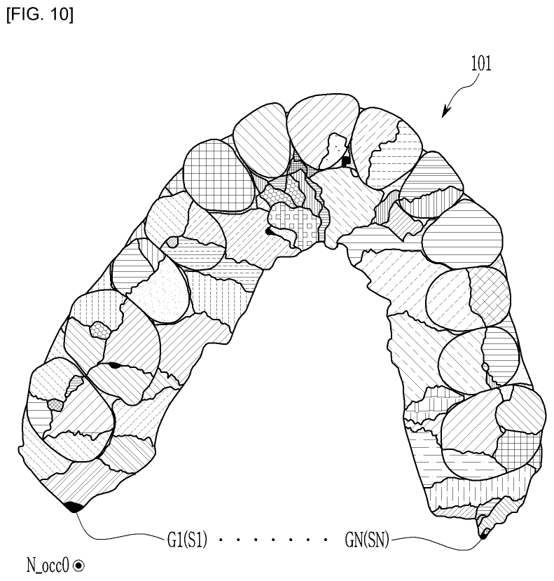

Referring additionally to FIGS. 7 and 8, the scan data 100 may include a plurality of meshes in a polygonal shape. As illustrated in FIG. 8, the mesh included in the scan data 100 may be in a triangular shape, but the shape is an example for easy description and may be a square, a pentagon, etc.

According to an exemplary embodiment, the electronic apparatus 20 may extract normal vectors n_1 to n_M for each mesh for the maxillary scan data 101 including M meshes.

The electronic apparatus 20 may extract an average normal vector N_avg based on the extracted normal vectors n_1 to n_M, as in the following Equation 1, and set the direction of the extracted average normal vector N_avg to the initial occlusal plane direction N_occ0.

$${\vec{n}}_{arg} = \frac{{\sum }_{i = 1}^{M} {\vec{n}}_{i} {s}_{i}}{\vert {\sum }_{i = 1}^{M} {\vec{n}}_{i} {s}_{i} \vert} \qquad ( Equation 1 )$$

In the Equation 1 above, \vec{n}_{avg} is a unit vector of the average normal vector

N_avg for the M meshes, \vec{n}₁ to \vec{n}_{M} are unit vectors of the normal vectors n_1 to n_M of the M meshes, and S₁ to Sₘ are the areas of the M meshes.

In FIGS. 7 and 8, the extraction of the initial occlusal plane direction N_occ0 is described using the maxillary scan data 101 as an example, but may vary according to the exemplary embodiment and is not limited to the above example. Hereinafter, the description of the maxillary scan data 101 in FIGS. 9 to 18 may also be applied to other scan data 100 including the mandibular scan data 102, and for ease of description, the description of the other scan data 100 will be described focusing on differences from the description of the maxillary scan data 101.

Referring to additionally to FIG. 9, according to an exemplary embodiment, the electronic apparatus 20 may generate a 3D-oriented bounding box (OBB) for the maxillary scan data 101 including the mesh data, extract a minimum edge vector N_OBB having an extension direction of a minimum edge L1 having a minimum length of the 3D-oriented bounding box OBB and a size of the minimum length, and set a minimum edge vector N_OBB to an initial occlusal plane direction N_occ0.

According to an exemplary embodiment, the electronic apparatus 20 may perform the convex hull algorithm on the scan data to generate the convex polyhedron including the vertices in the scan data, and generate the 3D-oriented bounding box for the generated convex polyhedron, extract the minimum edge vector having the extension direction of the minimum edge having a minimum length of the 3D-oriented bounding box and the size of the minimum length, as illustrated in FIG. 9, and set the minimum edge vector N_OBB to the initial occlusal plane direction. By generating the 3D-oriented bounding box for the convex polyhedron, the calculation processing amount for generating the 3D-oriented bounding box may be reduced, thereby increasing the efficiency of setting the initial occlusal plane direction.

According to an exemplary embodiment, the electronic apparatus 20 may generate the 3D-oriented bounding box for the scan data including the mesh data, and calculate the complexity of the surface curvature of the scan data in the normal direction of each surface of the 3D-oriented bounding box. The electronic apparatus 20 may set the direction of the initial occlusal plane direction in a direction that is parallel to the extension direction of the minimum edge having the minimum length of the 3D-oriented bounding box and proceeds from a surface with low complexity of the surface curvature to a surface with high complexity. In the case of scan data including a closed-surface tooth model, it may be efficient to set the initial occlusal plane direction by calculating the complexity of the 3D-oriented bounding box generation and surface curvature instead of the average normal vector.

Next, the electronic apparatus 20 generates the cusp information (S220). Referring to additionally to FIGS. 10 to 12, the electronic apparatus 20 may separate the maxillary scan data 101 into a plurality of image groups G1 to GN according to the curved shape of the maxillary scan data 101 by utilizing the curvature information, the cusp information, and the anatomical feature shapes, as illustrated in FIG. 10.

The electronic apparatus 20 may generate a plurality of local maximum points LM_1 to LM_N for the maxillary scan data 101 based on the initial occlusal plane direction N_occ0. The plurality of local maximum points LM_1 to LM_N may correspond to the vertices that are arranged highest based on the initial occlusal plane direction N_occ0 in each of the plurality of image groups G1 to GN constituting the maxillary scan data 101.

The electronic apparatus 20 may select cusp points cusp_1 to cusp_x from among the plurality of local maximum points LM_1 to LM_N based on the heights of the plurality of local maximum points LM_1 to LM_N for the initial occlusal plane direction N_occ0 and the plurality of areas S1 to SN for the plurality of image groups G1 to GN. The electronic apparatus 20 may select the cusp points cusp_1 to cusp_x by eliminating some of the plurality of local maximum points LM_1 to LM_N in the form of an elimination method based on the predetermined height and the predetermined area.

The cusp information may include the number and arrangement of cusp points cusp_1 to cusp_x that the molar contacts in the maxillary scan data 101. The electronic apparatus 20 may extract a post from the maxillary scan data 101 by considering the arrangement and number of cusp points cusp_1 to cusp_x through the cusp information. The post may include cusp points arranged in two rows along the arch.

According to an exemplary embodiment, the electronic apparatus 20 may recognize each tooth in the maxillary scan data 101 through an object recognition artificial intelligence algorithm at the corresponding stage, recognize the tooth number of the recognized teeth, and generate the cusp information by considering the anatomical features, etc., of the teeth according to the tooth number.

The electronic apparatus 20 sets the front direction and midline using the cusp information of the scan data 100 (S230).

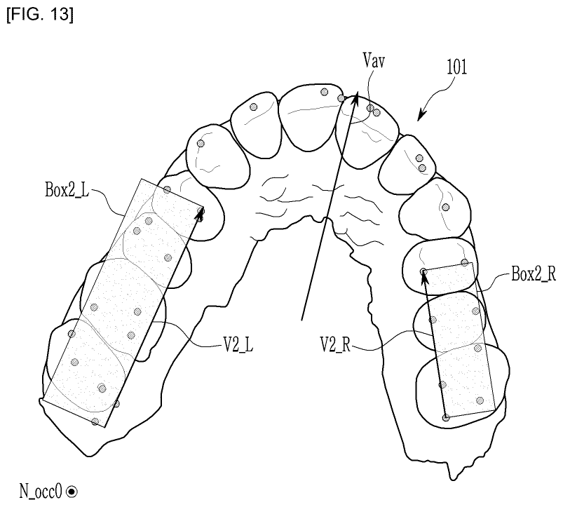

Referring additionally to FIGS. 13 to 15, the electronic apparatus 20 may generate a left 2D-oriented bounding box Box2_L and a right 2D-oriented bounding box Box2_R that are spaced apart from each other using the extracted post. The left 2D-oriented bounding box Box2_L may include the cusp point arranged at the left post in the maxillary scan data 101. The right 2D-oriented bounding box Box2_R may include the cusp point arranged at the right post in the maxillary scan data 101.

The left 2D-oriented bounding box Box2_L and the right 2D-oriented bounding box Box2_R may be included in the post, and the left 2D-oriented bounding box Box2_L and the right 2D-oriented bounding box Box2_R may be arranged to be spaced apart from each other left and right with the anterior as the center.

The electronic apparatus 20 may extract a left inner vector V2_L for the left inner long side arranged in the lingual direction from the left 2D-oriented bounding box Box2_L, and may extract a right inner vector V2_R for the right inner long side arranged in the lingual direction from the right 2D-oriented bounding box Box2_R. The left inner vector V2_L may have the length of the left inner long side as its size and have a direction in the extension direction of the left inner long side. The right inner vector V2_R may have a size equal to the length of the right inner long side and a direction in the extension direction of the right inner long side.

The electronic apparatus 20 may generate an average vector Vav of the extracted left inner vector V2_L and the right inner vector V2_R, and may set the front direction of the scan data 100 to the direction of the average vector Vav.

The electronic apparatus 20 may set a first reference point P1 and a second reference point P2 based on the arrangement of the left 2D-oriented bounding box Box2_L and the arrangement of the right 2D-oriented bounding box Box2_R, according to an exemplary embodiment. The first reference point P1 may be a cusp point closest to the first reference line BL1 that is located a predetermined distance L away from the short side of the left 2D-oriented bounding box Box2_L. The second reference point P2 may be a cusp point closest to the first reference line BL2 that is the predetermined distance L away from the short side of the right 2D-oriented bounding box Box2_R. The predetermined distance L is 10 mm to 20 mm, but is not limited thereto. According to the exemplary embodiment, the electronic apparatus 20 may set the first reference point P1 and the second reference point P2 through the object recognition of the cusp information in the left 2D-oriented bounding box Box2_L, the right 2D-oriented bounding box Box2_R, and the maxillary scan data 101.

According to the exemplary embodiment, the electronic apparatus 20 may recognize and set a maxillary left first molar Mo1_L and a maxillary right first molar Mo1_R through the object recognition artificial intelligence algorithm for the maxillary scan data 101.

The electronic apparatus 20 may select a cusp point located in the buccal direction among the cusps in the first molar Mo1_L and Mo1_R as an outer cusp, and set the outer cusp closest to the anterior among the selected outer cusps as the first reference point P1 and the second reference point P2.

The electronic apparatus 20 may set a midpoint of the first reference point P1 and the second reference point P2 as a midpoint CMo, and designate a point moved by the average vector Vav from the midpoint CMo as an adjacent reference point PP. The electronic apparatus 20 may set the cusp point of the mandibular scan data 102 that is closest to the adjacent reference point PP as a third reference point P3.

The electronic apparatus 20 may set an extension line that passes through the third reference point P3 and extends in the direction of the average vector Vav as a midline Cc.

The electronic apparatus 20 adjusts the midline Cc to an adjustment midline Cc′ (S240).

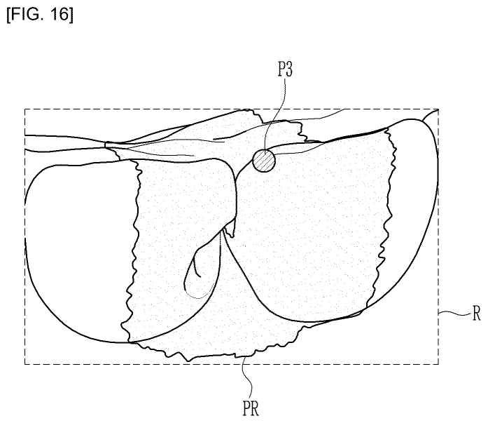

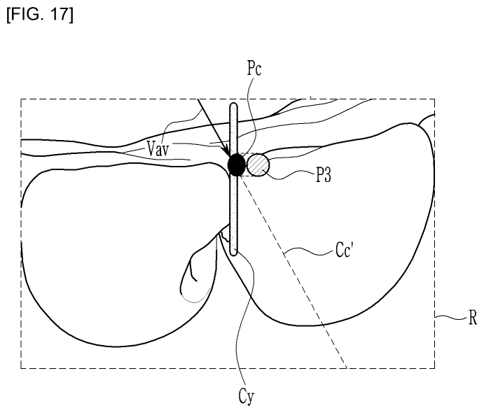

Referring additionally to FIGS. 16 and 17, the electronic apparatus 20 may analyze the front shape of the maxillary scan data 101 and adjust the midline Cc to the adjustment midline Cc′. The front shape of the maxillary scan data 101 may be expressed in the opposite direction of the average vector Vav.

The electronic apparatus 20 may set a proximal region PR including the third reference point P3. According to an exemplary embodiment, the proximal region PR may be a region where the midline Cc is rotated within a certain range based on the midpoint CMo to meet the maxillary scan data 101. The certain range is −10° to 10°, but is not limited to the numerical range, and the numerical range may vary according to the exemplary embodiment.

The electronic apparatus 20 may obtain the curvature information in the maxillary scan data 101 within the proximal region PR and group the vertices in the maxillary scan data 101 having the curvature information in a certain range to recognize an interdental region between the central incisors. The electronic apparatus 20 may perform the cylinder fitting operation to generate a central cylinder Cy that extends adjacent to the maxillary scan data 101 along the interdental region recognized between the central incisors. The central cylinder Cy may contact the maxillary scan data 101.

The electronic apparatus 20 may set a central reference point Pc by projecting the third reference point P3 onto the central cylinder Cy in a direction perpendicular to the direction in which the central cylinder Cy extends. The electronic apparatus 20 may set an extension line extending in the direction of an average vector Vav passing through the central reference point Pc as the adjustment midline Cc′, and adjust the midline Cc by setting the adjustment midline Cc′. Through the adjustment operation, the electronic apparatus 20 may precisely align the maxillary scan data 101 by disposing the adjustment midline Cc′ between the central incisors.

According to the exemplary embodiment, the electronic apparatus 20 recognizes the interdental region between the central incisors in the maxillary scan data 101 through the object recognition artificial intelligence algorithm, and may adjust the midline Cc to the adjustment midline Cc′ by adjusting the central reference point Pc within the interdental area between the central incisors as the location of the third reference point P3.

The electronic apparatus 20 sets an occlusal plane OccP (S250).

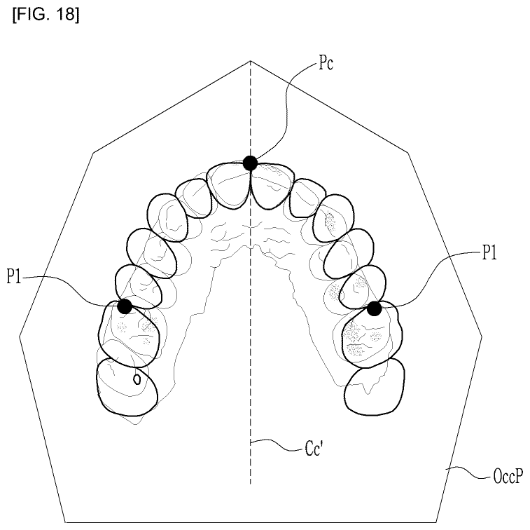

Referring to additionally to FIG. 18, the electronic apparatus 20 may set the occlusal plane OccP based on the first reference point P1, the second reference point P2, and the center reference point Pc. In addition to setting the occlusal plane OccP by setting the plurality of reference points P1, P2, and Pc, the electronic apparatus 20 may set the occlusal plane OccP in various ways, including calculating the plane equation by regressing the cusp information for the cusp points cusp_1 to cusp_x by a least square error method, according to the exemplary embodiment.

According to an exemplary embodiment, the electronic apparatus 20 may adjust the positions of the plurality of reference points P1, P2, and Pc based on the user input through the input of the user interface device 23 after setting the plurality of reference points P1, P2, and Pc, and the occlusal plane OccP may be set based on the plurality of adjusted reference points P1, P2, and Pc.

According to an exemplary embodiment, the electronic apparatus 20 does not require any separate user input other than loading the scan data 100 during the operation of step S200, so the scan data 100 may be easily aligned, thereby reducing the time required to manufacture the splint.

In addition, according to an exemplary embodiment, the electronic apparatus 20 may precisely align the scan data 100 by automatically disposing the midline between the central incisors.

The method for processing an image according to an exemplary embodiment of the present invention may be implemented in a form of program commands that may be executed through various computer means and may be recorded in a computer-readable recording medium. In addition, an embodiment of the present disclosure may be a computer-readable recording medium on which one or more programs including commands for executing an image processing method are recorded.

The computer-readable medium may include a program command, a data file, a data structure, or the like, or a combination thereof. The program commands recorded in the computer-readable recording medium may be especially designed and configured for the present disclosure or be known to those skilled in a field of computer software. Examples of the computer-readable recording medium may include a magnetic medium such as a hard disk, a floppy disk, or a magnetic tape; an optical medium such as a compact disk read only memory (CD-ROM) or a digital versatile disk (DVD); a magneto-optical medium such as a floptical disk; and a hardware device specially configured to store and execute program commands, such as a ROM, a random access memory (RAM), a flash memory, or the like. Examples of the program commands include high-level language codes capable of being executed by a computer using an interpreter, or the like, as well as machine language codes made by a compiler.

Here, the machine-readable storage medium may be provided in a form of a non-transitory storage medium. Here, the “non-transitory storage medium” means that the storage medium is a tangible device, and does not include a signal (for example, electromagnetic waves), and the term does not distinguish between the case where data is stored semi-permanently on a storage medium and the case where data is temporarily stored thereon. For example, the “non-transitory storage medium” may include a buffer in which data is temporarily stored.

According to an embodiment, the methods according to various embodiments disclosed in the document may be included in a computer program product and provided. The computer program product may be traded as a product between a seller and a purchaser. The computer program product may be distributed in the form of a machine-readable storage medium (for example, compact disc read only memory (CD-ROM)), or may be distributed through an application store (for example, Play Store™) or may be directly distributed (for example, download or upload) between two user devices (for example, smart phones) online. In a case of the online distribution, at least some of the computer program products (for example, downloadable app) may be at least temporarily stored in a machine-readable storage medium such as a memory of a server of a manufacturer, a server of an application store, or a relay server or be temporarily created.

Although exemplary embodiments of the present disclosure have been described in detail hereinabove, the scope of the present disclosure is not limited thereto, but may include several modifications and alterations made by those skilled in the art using a basic concept of the present disclosure as defined in the claims.

1. A method for processing an image, comprising:
receiving at least one intraoral image;
calculating based on scan data corresponding to the at least one intraoral image;
setting a plurality of reference points in the scan data based on the calculating; and
aligning the scan data based on an occlusal plane generated based on the plurality of reference points.

2. The method of claim 1, further comprising:
adjusting positions of the plurality of reference points through an external input,
wherein the occlusal plane is generated based on the positions of the plurality of adjusted reference points.

3. The method of claim 1, wherein:
the calculating based on the scan data includes:
extracting an initial occlusal plane direction of the scan data based on mesh data included in the at least one scan data;
generating cusp information of the scan data;
setting a front direction and a midline of the scan data based on the cusp information; and
adjusting the midline based on a front shape of the scan data in the front direction.

4. The method of claim 3, wherein:
the extracting of the initial occlusal plane direction includes
processing a normal vector of the mesh data to obtain an average normal vector.

5. The method of claim 3, wherein:
the extracting of the initial occlusal plane direction includes:
generating a three-dimensional (3D)-oriented bounding box including the mesh data; and
extracting a vector for a minimum edge having a minimum length in the 3D-oriented bounding box.

6. The method of claim 3, wherein:
the generating of the cusp information includes:
generating a plurality of local maximum points in the scan data based on the initial occlusal plane direction; and
selecting a cusp point from among the plurality of local maximum points.

7. The method of claim 3, wherein:
the generating of the cusp information includes:
recognizing tooth numbers of a plurality of teeth in the scan data through an artificial intelligence algorithm; and
generating the cusp information for the scan data based on features of the tooth numbers.

8. The method of claim 3, wherein:
the setting of the front direction and the midline of the scan data includes:
extracting a post from the scan data based on the cusp information; and
generating first and second 2D-oriented bounding boxes included in the post and spaced apart from each other.

9. The method of claim 8, wherein:
the setting of the front direction includes:
extracting first and second inner vectors for first and second inner long sides arranged adjacent to each other in each of the first and second 2D-oriented bounding boxes; and
generating an average vector of the first inner vector and the second inner vector.

10. The method of claim 9, wherein:
the setting of the midline includes:
setting a first reference point within the first 2D-oriented bounding box and a second reference point within the second 2D-oriented bounding box; and
setting a third reference point based on an average vector extending from a midpoint of the first reference point and the second reference point.

11. The method of claim 10, wherein:
the adjusting of the midline includes:
setting a proximal region including the third reference point;
performing cylinder fitting based on curvature information of the scan data within the proximal region to generate a central cylinder; and
projecting the third reference point onto the central cylinder in a direction perpendicular to the direction in which the central cylinder extends to set a central reference point.

12. An electronic apparatus, comprising:
a user interface device;
a processor; and
a memory configured to store instructions executable by the processor,
wherein the processor is configured to execute the instructions to:
receive at least one intraoral image;
calculate based on scan data corresponding to the at least one intraoral image;
set a plurality of reference points in the scan data based on the calculation of the scan data; and
align the scan data based on an occlusal plane generated based on the plurality of reference points.

13. The electronic apparatus of claim 12, wherein:
the processor is configured to adjust positions of the plurality of reference points through an external input; and
the occlusal plane is generated based on the positions of the plurality of adjusted reference points.

14. The electronic apparatus of claim 12, wherein:
the calculating based on the scan data includes:
extracting an initial occlusal plane direction of the scan data based on mesh data included in the at least one scan data;
generating cusp information of the scan data;
setting a front direction and a midline of the scan data based on the cusp information; and
adjusting the midline based on a front shape of the scan data in the front direction.

15. The electronic apparatus of claim 14, wherein:
the extracting of the initial occlusal plane direction includes
processing a normal vector of the mesh data to obtain an average normal vector.

16. The electronic apparatus of claim 14, wherein:
the extracting of the initial occlusal plane direction includes
generating a three-dimensional (3D)-oriented bounding box including the mesh data; and
extracting a vector for a minimum edge having a minimum length in the 3D-oriented bounding box.

17. The electronic apparatus of claim 14, wherein:
the generating of the cusp information includes:
generating a plurality of local maximum points in the scan data based on the initial occlusal plane direction; and
selecting a cusp point from among the plurality of local maximum points.

18. The electronic apparatus of claim 14, wherein:
the generating of the cusp information includes:
recognizing tooth numbers of a plurality of teeth in the scan data through an artificial intelligence algorithm; and
generating the cusp information for the scan data based on features of the tooth numbers.

19. The electronic apparatus of claim 14, wherein:
the setting of the front direction and the midline of the scan data includes:
extracting a post from the scan data based on the cusp information; and
generating first and second 2D-oriented bounding boxes included in the post and spaced apart from each other.

20. A computer readable storage medium including computer readable instructions,
wherein the instructions cause the computer to:
receive at least one intraoral image;
calculate based on scan data corresponding to the at least one intraoral image;
set a plurality of reference points in the scan data based on the calculating; and
align the scan data based on an occlusal plane generated based on the plurality of reference points.
